(19) United States
(12) Patent Application Publication
(10) Pub. No.: US 2008/0033773 A1
(43) Pub. Date: Feb. 7, 2008

(54) METHOD FOR CONDUCTING MARKET RESEARCH

(76) Inventor: Jeff D. Brazell, Salt Lake City, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/834,609

(22) Filed: Aug. 6, 2007

Related U.S. Application Data
(60) Provisional application No. 60/836,005, filed on Aug. 7, 2006.

(51) Int. Cl. G06Q 30/00; G06F 17/30

(52) U.S. Cl. 705/7; 705/26; 705/27

(57) ABSTRACT

A method of conducting market research includes allowing respondents to select products in a virtual online store. An additional virtual online store allows respondents to select accessory products or media for the previously selected products. Various steps in the research may collect information about how the product is used.

### RELATED APPLICATIONS

The present application claims the benefit of U.S. Provisional Application Ser. No. 60/836,005, filed Aug. 7, 2006, which is incorporated herein in its entirety.

### BACKGROUND OF THE INVENTION

1. The Field of the Invention

The present invention relates to market research. More specifically, the present invention relates to improved methods of market research and consumer research which are believed to more accurately assess consumer needs and desires.

2. State of the Art

Existing methods of consumer research and data gathering provide useful, although typically limited, information regarding consumers. Manufacturers and retailers typically desire to know what consumers are interested in purchasing, or what their product preferences are.

It is thus common to perform research and collect such consumer data, typically in some form of consumer survey. Consumers are often asked which brand they purchase, which food tastes better, which of these items is better, etc. Such questions provide information to interested parties such as manufacturers and advertising agents.

There is a need for consumer survey and market research methods which provide more realistic information regarding consumer needs and decision making processes. There is a need for research methods which provide consumer choice and preference data which is more accurate to real life purchasing decisions, and which provides insight into the actual use of the product.

### SUMMARY OF THE INVENTION

It is an object of the present invention to provide improved methods of consumer research and data collection.

According to one aspect of the invention, consumer information is collected in a virtual shopping experience. The experience may be crafted to replicate the decisions that a consumer would make if actually purchasing the product.

According to another aspect of the invention, a variety of related types of consumer information may be collected together so as to provide more complete understanding of the purchasing procedure. A survey environment and procedure may be established which allows understanding of how, when and where a product is most likely to be used, and which other products are most likely to be used in combination with the product.

These and other aspects of the present invention are realized in a method for conducting market research as shown and described in the following figures and related description.

### BRIEF DESCRIPTION OF THE DRAWINGS

Various embodiments of the present invention are shown and described in reference to the numbered drawings wherein:

FIG. 1 shows a representation of a virtual online store according to the present invention;

FIG. 2 shows a representation of a virtual online store according to the present invention;

FIG. 3 shows a representation of a virtual online store according to the present invention;

FIG. 4 shows a representation of a virtual online store according to the present invention;

FIG. 5 shows a representation of a virtual online store according to the present invention;

FIG. 6 shows a representation of a virtual online store according to the present invention; and

FIG. 7 shows a representation of a virtual online store according to the present invention.

It will be appreciated that the drawings are illustrative and not limiting of the scope of the invention which is defined by the appended claims. The various embodiments shown accomplish various aspects and objects of the invention. It is appreciated that not all aspects of the invention may be clearly shown in a single figure. Thus, multiple figures may be used to illustrate the various aspects of a single embodiment of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

The present invention involves the collection of consumer data via the simulation of a virtual online store. The virtual online store is typically presented to a respondent online (in an internet based format), and is designed to simulate an internet retailer.

One aspect of the present invention is the linking various different research tools together in a manner which allows more accurate and more complete collection of information from a respondent. Thus, the present invention may link together an introductory session providing instructions and possible collecting information from the respondent, a virtual online store in which the respondent may select desired products as though purchasing the products, an information collecting session or “diary” session in which information regarding the use and desired use of existing and newly selected products is gathered from the respondent, and another virtual online store shopping experience where the respondent may select accessory products for use with the previously selected products. During all stages of the research method, desired information may be collected from the respondent by direct questioning, inferences from question answers, tracking of browsing and product selection while “shopping,” time spent in decision-making processes, and the like.

Aspects of the present invention will be illustrated by describing the survey process in context of electronics, and more specifically electronic devices for playing video. It is appreciated that the same methods may be applied to many other suitable types of products and services. The description herein should be understood as being applicable to all types of products.

The Electronics Store

A large number of persons, such as 500 persons, typically participate in an on-line research study. These people will be asked to participate based on criteria consisting of their demographic profile as well as other selection criteria. The study may be replicated with a new set of 500 people every week, every other week, or every month, in order to provide current data and information regarding the desired products and services.

Although not strictly necessary, the survey is typically conducted in an online environment. The use of an online environment allows for certain advantages in creating an experience which provides more accurate information regarding the consumer respondent.

The respondents will typically open the survey, such as by opening a web page, and be given some clearly written information describing what the study is and what they will be expected to do.

In the case of electronic video devices, the respondent will typically be asked what video display equipment they already own. They will be then typically be asked how much money they intend to spend on new video related equipment over the next 12 months (or other desired period of time). The respondent may be asked how much they spent in the previous 12 months. The respondents may also be asked to consider which types of devices they desire to purchase and how such devices may be used, prompting the respondent to more accurately assess their likely future purchasing.

The respondent will then open a virtual electronics store. The virtual electronics store may be created to mimic the look and feel of an online retailer. This mimicry aids in making the virtual shopping experience as similar as possible to an actual shopping experience, and may aid in obtaining more accurate consumer information. Respondents will be asked to select the electronic devices they expect to purchase over the coming 12 months (or other time period) from a variety of video related devices.

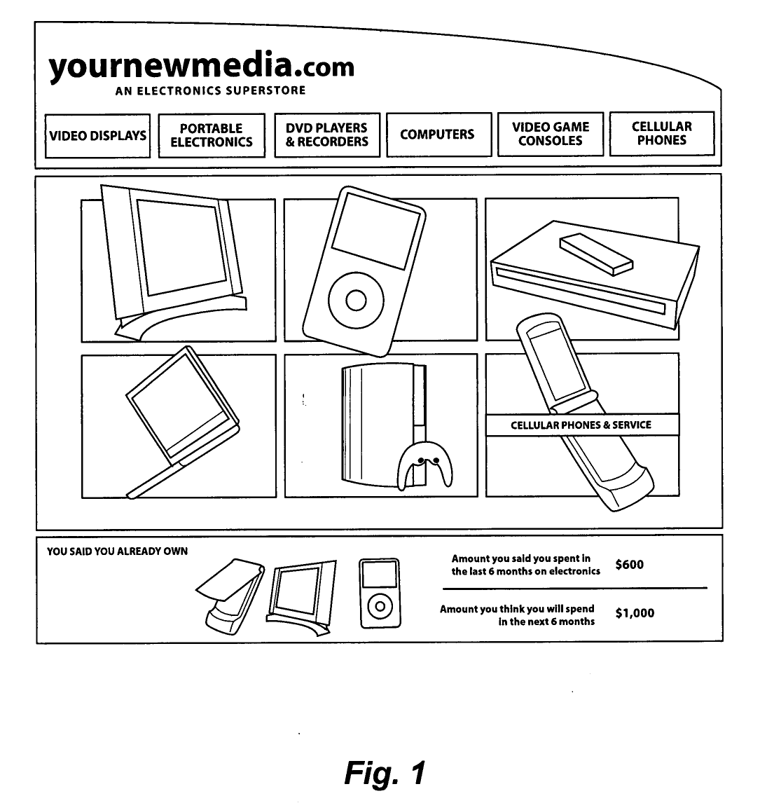

In recreating the look and feel of an online retailer, the data collection procedure will typically present various categories of devices that are available in the store to the respondent. The devices may include: video displays such as TVs, flat panels, rear projectors, front projectors, etc.; desk top and lap top computers; personal video devices e.g. iPods®, hand held video game devices; cell phones; and console gaming devices; video set-top boxes e.g. Tivo®, digital video recorders, HD tuners, etc. FIG. 1 shows such a virtual online store as may be used according to the present invention. It will be appreciated that, where survey information is desired for other types of products, an online store experience will be created which presents different types of products to the respondent/participant.

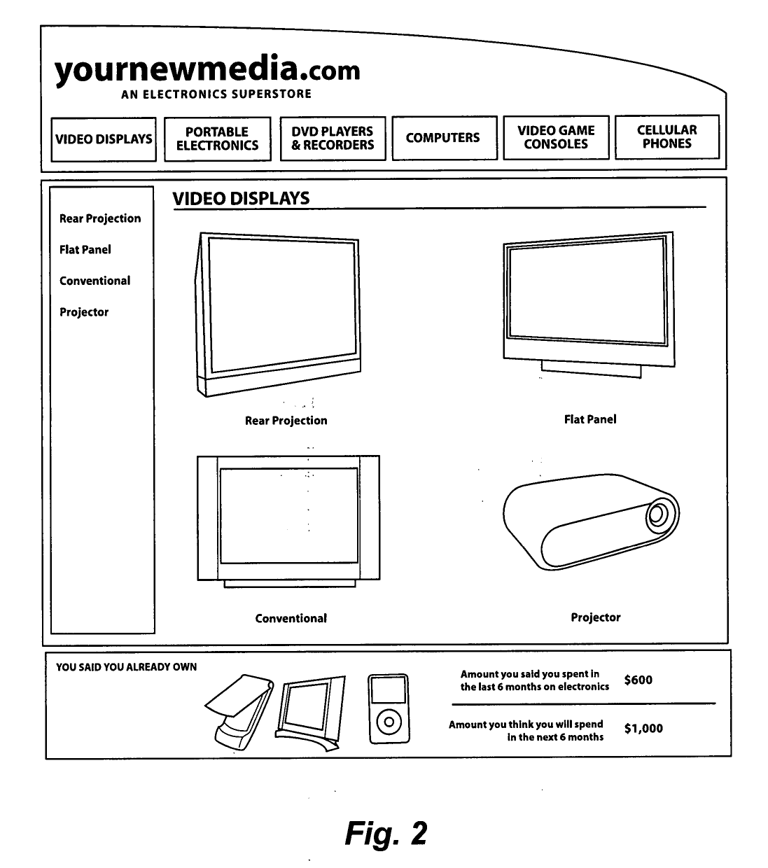

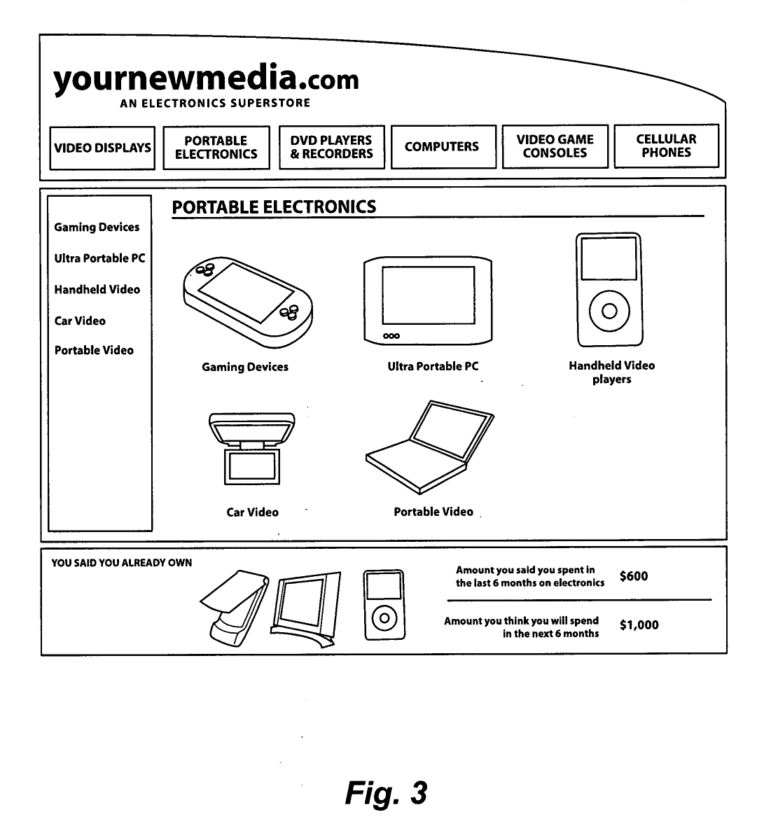

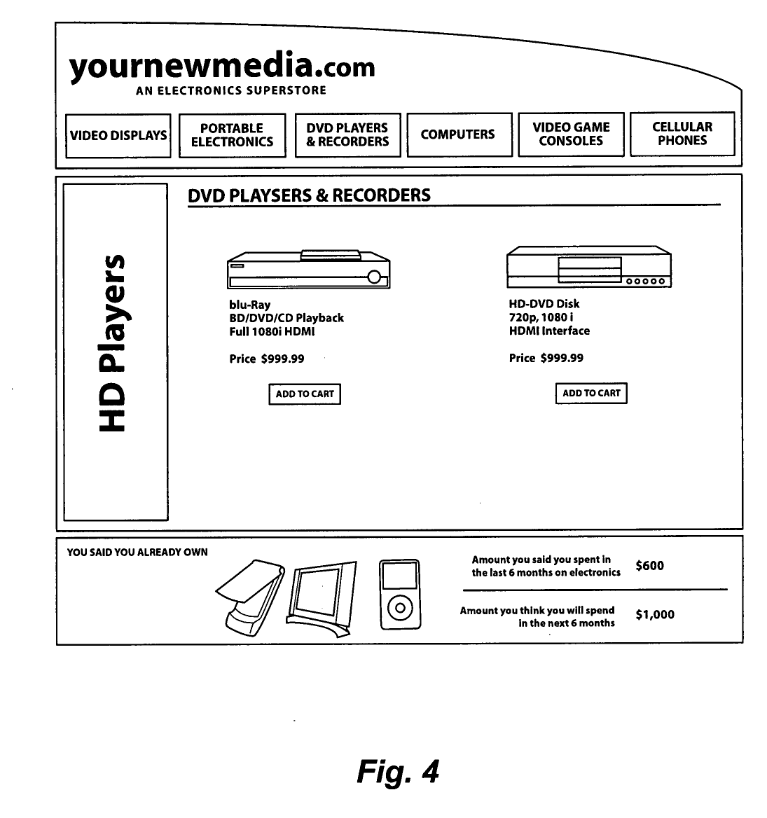

The respondent may navigate the virtual store in a similar manner as a conventional online store. Respondents may click on the navigation tabs representing product types in which they are interested. In keeping with the virtual store experience, clicking on a type of product, such as video displays or portable electronics, will move the respondent to a new screen showing a variety of products in the desired category. Such is shown in FIGS. 2, 3, and 4. These screens may show specific products, or may allow the respondent to further select a specific type of product, bringing up a new screen displaying the desired type of product.

Respondents can select the device they are interested in purchasing. The online store typically includes information about a product, such as price, features, etc., allowing respondents to decide exactly which products they are interested in. Thus, respondents will typically be able to see the features and functions of the specific device of their interest. The online store may thus provide product information such as features, compatibility, warranty, etc. as would be typically used by a consumer in making a purchasing decision. (Of course, the price and features may be varied to determine the effect of price and features on the customer's decision making.)

Respondents may “purchase” (select) a device they want similar to a purchasing experience at an actual online store. The virtual store may be equipped with a shopping cart. Similarly, respondents may decide that they do not want to “purchase” an item and may remove the item from the shopping cart. They may then go back to the navigation tabs along the top of the page and choose to look at and select another device.

When the respondent clicks on a “check out” button the products are selected as through purchased. The respondent may be provided with an amount spent, hypothetical shipping costs, etc. to help them in finalizing their decision. The respondent may be reminded that they were planning to spend a given amount of money on electronics over the next 12 months. If desired, the respondent may be left unconfined to that amount (we all exceed our budgets from time to time) but it is typically desirable to limit them in their “purchasing” so as to create a realistic virtual shopping experience which provides better information regarding the consumer.

It is possible, according to the desires of the final data users, to track the amount of time respondents spends on each page, and to track what they looked at and what they did not. The method, however, will typically track what they “bought” and what they did not select from the virtual store.

By providing such an experience, the method allows respondents to consider what electronic devices they desire, what their spending budget will be, and be able to then select devices in a manner which recreates an actual shopping experience. The method thus aids in providing more accurate information by more accurately recreating a real life purchasing experience. The method also allows a determination of the effect of price and features without directly asking the respondent to directly provide this information. If directly asked, respondents may not assess and communicate the effect of price or features as accurately may be determined from collecting information from a simulated retail environment.

After the respondents check out of the electronics store, they will typically be shown a screen which will ask them several questions to determine why certain products were selected, and what features are most desirable in those products.

Collecting more accurate purchasing information is advantageous, but the information may be augmented and made more useful by focusing respondents on real activities that have happened in their lives. The media store experience may then be focused on specific activities that have recently happened in respondents lives. This aspect to the method may be included as it may have a positive affect on the validity of the exercise. This aspect of the method may be referred to as the diary.

The diary information may be completed by respondents during the days before the main data collection or may be collected as part of the main data collection exercise. Respondents may be asked about what situations they were in over the previous several days during which they watched video media, or during which they might have watched video media if they had had the new video devices which they purchased in the virtual electronics store.

Respondents may then be asked to classify the viewing situation by its personal involvement, i.e. were they watching with friends, were they alone, were they in a dark room watching a movie, were they in a family room watching TV, were there other things happening at the same time, was the video media important or were they just “killing time”, were they on the internet, were they waiting for another function, were they commuting, etc.

Respondents may then be asked how long the viewing situation lasted. They may also be asked which video viewing device they were watching during the viewing situation. For situations in which respondents did not have the desired device, they may be asked which device they would have preferred to use in the situation if it had been available.

Respondents may be asked how often these particular situations occur in which they desire to watch video content, how long the situations last, etc. By collecting such information, the present methods provide insight into how devices are used by the respondent. It is thus possible to better determine why a product was purchased. It is possible to determine what features an electronic device needs to be useful to the respondent in the various situations where the respondent would desire to use the device.

The respondent may then be directed into a media content store. Respondents will typically be asked to think about the viewing situations which they described in their diary and “purchase” (select) from the media content store the media content which they would have liked to have viewed in those situations. Respondents may be reminded of the situations in which they desired to watch media, and may be asked which electronic device they would use or would wish to use in that situation. The respondent may be asked what media they would purchase for various media devices: e.g. What would you purchase for an iPod? What media would you purchase to view on your cell phone? What would you purchase to view on your home theater? etc.

To answer the above questions, the respondents would typically enter the virtual media content store. The media content store is typically formed to be similar to a conventional online retailer, with the exception of certain functionality as discussed.

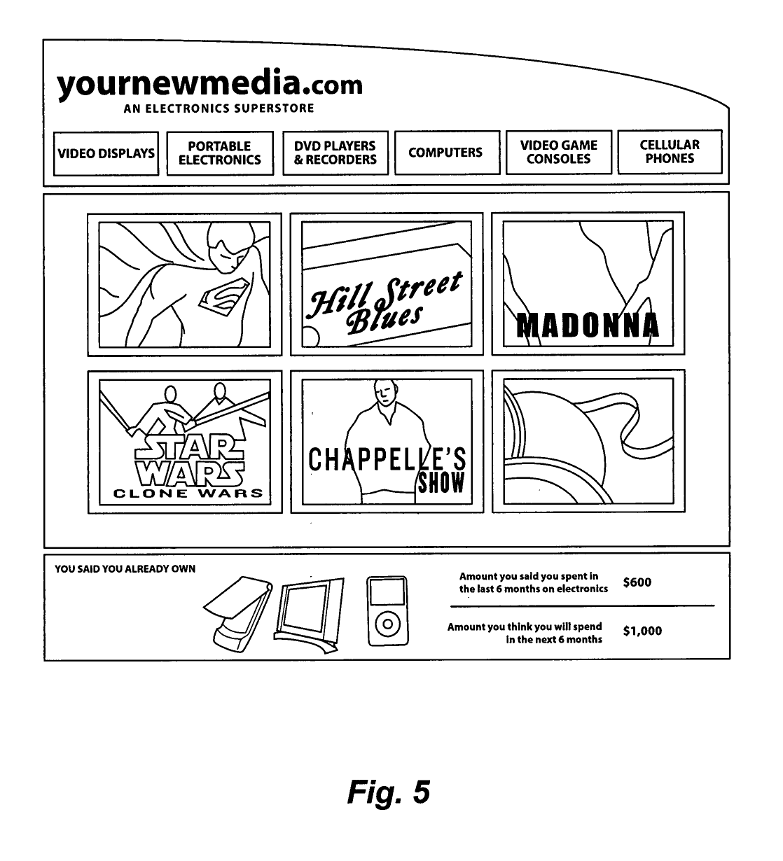

The content store is displayed in FIG. 5. The content store is typically created to mimic the look and feel of an online store, having navigation tabs, a shopping cart, a checkout, etc. as described herein. The respondent may navigate in a manner as described above to select media from the content store. The types of content may typically include movies, video games, TV shows, and short features. Additionally, the content store may allow a respondent to select media by length, by genre, etc.

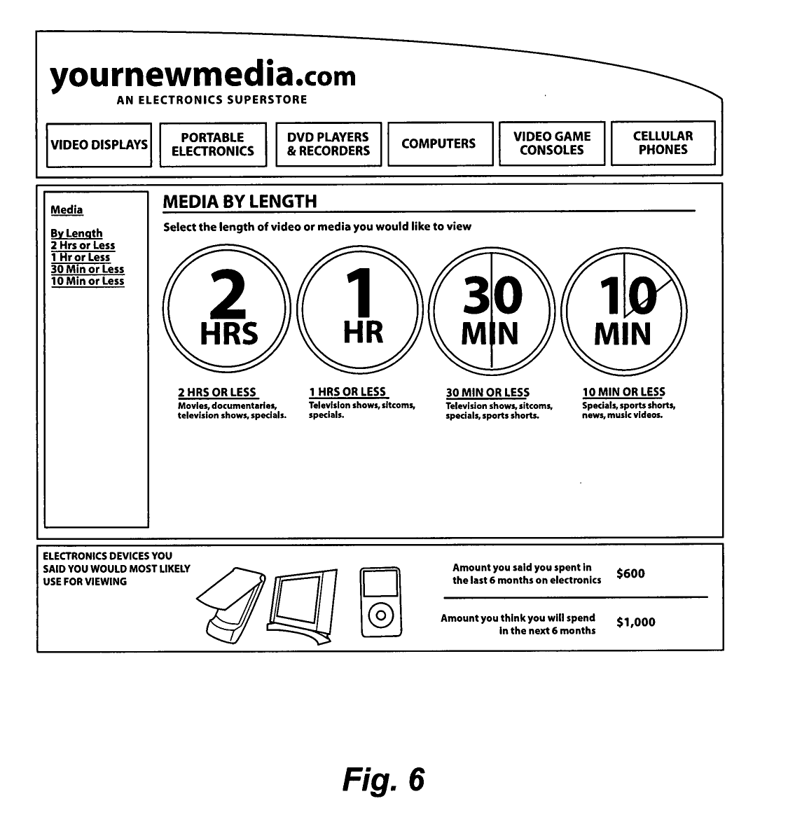

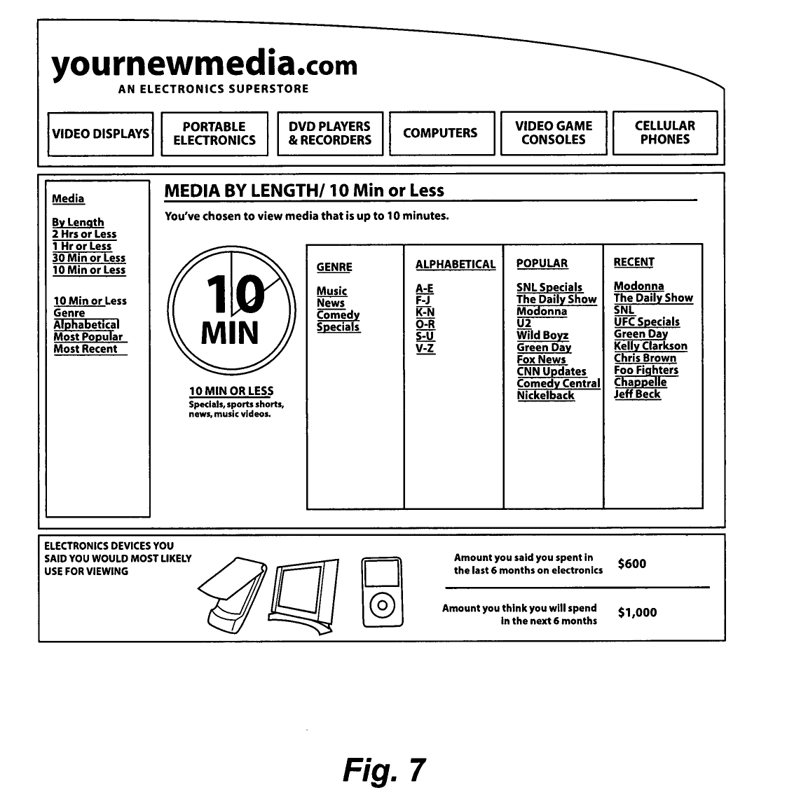

FIG. 6 shows a page of the content store where a respondent may browse media by time length. FIG. 7 shows a further screen where, after selecting media of 10 minutes or less, the respondent may select media based on genre, title, or based on popular or recent choices. The media content store is thus created to allow a user to easily browse and select media. The respondent would then put the selected media in their shopping cart. The respondent could then re-navigate to any part of the Content Store to select more media.

The content store may be created to operate in a variety of different ways. The respondent may select an electronic device and then select media for that particular device. Alternatively, the respondent may be asked which device the media is for while selecting a particular media. This and the following information may be collected when selecting media, at checkout, after checkout, etc.

Respondents will typically be asked what means of acquiring the content is preferable. Respondents may select from a variety of means, such as purchasing the media on tangible medium such as DVD, CD, or flash media, downloading the media on demand to a device, etc. Respondents may also be asked what price they are willing to pay for the various video media they have selected. Respondents may alternatively be asked about their willingness to pay different amounts for different length or types of content. (Alternatively, prices can be changed over a number of respondents to determine appropriate price points.)

Respondents may also be asked if they would be willing to watch commercials during the media if the price of the media was reduced. Thus, respondents may be asked if they would be willing to watch one commercial if the expected price was reduced by ⅓, or watch two commercials if the price was reduced by ⅔, or if there were three or more commercials the content might be provided for free. Respondents may be asked about acceptable types of advertising for a particular type of media or a particular electronic device. Typically, these questions are in the guise of “pricing” attached to pieces of media.

Following the virtual shopping experiences, the respondents will typically be asked to complete a brief demographic questionnaire. The questionnaire will address typical concerns such as gender, ethnicity, age, level of education, etc.

Although discussed in reference to electronic devices which play video media, the above methods are generally applicable to many other types of products, such as electronics for games or audio media, computer equipment, etc., as well as a host of other products.

The present research methods are advantageous as they provide more complete information. The above method allows determination of how and when a device is used, where the device is used, or how long the product is used, what type of content is desired for the device, how much advertising is acceptable when watching media content on the device, what price is acceptable for the media, etc. The information is gathered in a way that may allow the estimation of sophisticated mathematical models that are more accurate in predicting consumer behaviors that other methods.

Such information allows device manufacturers to determine what features are necessary or desirable on a particular device. For example, cell phone makers may determine how much memory is needed for downloaded media, how much processing capability is needed for playing the media and downloading the media, whether media should be stored or streamed to the device, etc.

Media producers may determine what media is in demand, what devices are likely to be used for a particular type of media, how the media should be provided to the user, how much to charge, how much embedded advertising is acceptable, etc.

It may be determined how and when consumers use the various types of devices, and how consumers may wish to use the devices if such features were supported.

There is thus disclosed an improved method for conducting market research. It will be appreciated that numerous changes may be made to the present invention without departing from the scope of the claims. For example, while particularly suited to media as described herein, the methods of the present invention may be applied to many types of products or services.

What is claimed is:

1. A method of performing market research comprising:
a respondent determining how much they are likely to spend on a type of product;
allowing the respondent to browse for and select a first product in a virtual online store;
obtaining from the respondent information about how the first product will be used; and
allowing the respondent to browse for an accessory product to be used with the first product in a virtual online store.

2. The method of claim 1, wherein the first product is an electronic device.

3. The method of claim 2, wherein the first product is a video media player.

4. The method of claim 3, wherein the accessory product is video media.

5. The method of claim 1, wherein the virtual online store allows a respondent to view product features and information for products presented in the online store.

6. A marketing medium comprising:
an input screen configured for inputting information about a person being surveyed;
at least one first sales screen configured for displaying product for the person being surveyed to choose from; and
at least one second sales screen for displaying product for the person being surveyed.

7. The marketing medium according to claim 6, wherein the at least one second sales screen is configured to display accessories from a product selected on the at least one first sales screen.

8. The marketing medium according to claim 6, wherein the at least one first sales screen and the at least one second sales screen provide an indication of an amount the person being surveyed has indicated he or she is likely to spend on a type of product over a given time.

9. The marketing medium according to claim 8, wherein the at least one first sales screen and the at least one second sales screen provide an indication of the amount spent on products selected.

10. The marketing medium according to claim 9, wherein the at least one first sales screen displays electronics for viewing media, and wherein at least one of the at least one second sales screen displays media for playing on the electronics on the at least one first screen.

11. A method for obtaining marketing information, the method comprising:
obtaining information about a person being surveyed;
allowing the person being surveyed to navigate through a virtual online store to indicate purchase decisions;
recording information about the purchasing decisions of the person being surveyed.

12. The method according to claim 11, wherein the method comprises obtaining and displaying information about the amount the person being surveyed has spent in a given time period and the amount the person intends to spend in a given time period.

13. The method according to claim 11, wherein the virtual online store is configured to show accessories for a product once the product has been selected.

14. The method according to claim 11, wherein the virtual online store is configured to show media playable on a product once the product has been selected.

15. The method according to claim 11, wherein the step of obtaining information about the person comprises obtaining information about what activities or events the person has participated in during a recent period of time.

16. The method of claim 15, wherein the method further comprises obtaining information about activities or events where the person would have used a particular product or service.

17. The method of claim 16, wherein the method comprises allowing the person to view and purchase items corresponding to said product or service in the online store to select which particular items of said product or service the person would purchase for use in said activities or events.

18. The method of claim 17, wherein the method further comprises tracking the person's product viewing behavior while the person is participating in the online store.

19. The method of claim 18, wherein the method comprises tracking how long the person spends viewing particular products.
